(19) United States
(12) Patent Application Publication
(10) Pub. No.: US 2015/0039710 A1
(43) Pub. Date: Feb. 5, 2015

(54) SYSTEM AND METHOD FOR SENDING AND RECEIVING ACTION-BASED DIGITAL GREETING CARDS

(71) Applicant: John C. FEGHALI, Pittsburgh, PA (US)

(72) Inventor: John C. FEGHALI, Pittsburgh, PA (US)

(21) Appl. No.: 14/452,189

(22) Filed: Aug. 5, 2014

Related U.S. Application Data
(60) Provisional application No. 61/862,483, filed on Aug. 5, 2013.
(60) Provisional application No. 61/896,189, filed on Oct. 28, 2013.

(51) Int. Cl. H04L 12/58

(52) U.S. Cl. CPC H04L 51/10
USPC 709/206

(57) ABSTRACT

Systems and methods are described herein that allow computing device users to send and receive encapsulated messages, such a greeting cards, consolidating input from more than one user into a single greeting card. Sensors on a computing device, such as a smartphone, may be used to simulate an action that triggers an encapsulated message to be transmitted or retrieved.

### CROSS REFERENCE TO PRIOR APPLICATIONS

This application claims priority under 35 U.S.C. §119(e) to U.S. Provisional Patent Application No. 61/862,483, filed Aug. 5, 2013, titled “Action Based Input Using Smartphone, Tablet or Computer Sensors to Encapsulate and Read or/and Listen or/and View a Digital Greeting Card,” and to U.S. Provisional Patent Application No. 61/896,189, filed Oct. 28, 2013, titled “Provisional Patent Application for Digital Group Greeting Card Based on Input Coming from Different Individuals and Consolidated Into One Card”, the disclosures of which are hereby expressly incorporated herein by reference in their entirety. This application is related to co-pending U.S. patent application Ser. No. 14/301,951, filed Jun. 11, 2014, titled “System and Method for Action-Based Input Text Communication,” the disclosure of which is hereby expressly incorporated herein by reference in its entirety.

### BACKGROUND

The present disclosure relates generally to electronic communications, and more particularly to associating actions with sending or receiving electronic greeting cards.

Electronic greeting cards are becoming increasingly popular. There are existing applications that allow a user to send a greeting card or invitation electronically to one or more recipients. These electronic greeting cards may include limited text, graphics, sound, etc. Because these graphical options are limited, there exists a need for an ability to encapsulate a message within such an expression and to associate user action with sending or receiving a message in, e.g., text messaging systems.

### SUMMARY OF THE DISCLOSURE

According to one aspect of the disclosure, a method for sending an encapsulated group message is described herein, the encapsulated group message including input from at least two senders. The method comprises initiating a group message by selecting a group message format, the group message format specifying one or more actions to be performed by each sender of the group message; transmitting the group message to each sender along with instructions for providing input; receiving, from each sender, input for the group message, wherein the input includes sensor data collected from a sending device; correlating the sensor data with the one or more actions to be performed by each sender of the group message; and transmitting the group message to at least one receiver.

The group message format further may further specify an action to be performed by the at least one receiver to view the group message.

The sensor data may be collected from at least one sensor associated with the sending device. The at least one sensor may comprise a touch screen, a light sensor, an accelerometer, a proximity sensor, a gyroscope, a camera, a compass, a temperature sensor, a GPS sensor, a fingerprint sensor, a speech recognition sensor, or a microphone.

The group message may comprise a greeting card, the greeting card including one or more of a text message, an image message, a sound message and a video message.

The one or more actions may mimic a real world activity.

The method may further include setting a deletion time for deleting the group message. The method may further include receiving a confirmation that the group message was viewed at the receiving device.

The sensor data may comprise one or more of a representation of device movement, a representation of a sound generated, a representation of light intensity, a representation of a location of the device, a representation of speech recognition, and a representation of an orientation of the device.

The method may further include selecting a delivery method for transmitting the group message to each sender; and entering an identifier for each sender, wherein the identifier type is based on the selected delivery method. The identifier may comprise an email address, a telephone number, or a custom user identification.

According to some aspects of the disclosure, a method for sending an encapsulated group message is described, the encapsulated group message including input from at least two senders. The method may include initiating a group message by selecting a group message format, the group message format specifying one or more actions to be performed by each sender of the group message; receiving, from each sender, input for the group message, wherein the input includes sensor data collected from a sending device; correlating the sensor data with the one or more actions to be performed by each sender of the group message; and transmitting the group message to at least one receiver.

According to some aspects of the disclosure, a method for sending an encapsulated group message is described, the encapsulated group message including input from at least two senders. The method may comprise initiating a group message, the group message format specifying one or more actions to be performed by each sender of the group message; transmitting the group message to each sender along with instructions for providing input; correlating the sensor data with the one or more actions to be performed by each sender of the group message; and transmitting the group message to at least one receiver.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 is a block diagram illustrating one aspect of a system for sending and receiving encapsulated messages.

FIG. 2 is a block diagram illustrating an example of a computing device for sending or receiving encapsulated messages.

FIG. 3 illustrates aspects of an encapsulated messaging component.

FIG. 4 is a flow chart depicting a method for sending an encapsulated group message.

FIG. 5 is a flow chart depicting a method for receiving an encapsulated message.

FIG. 6 depicts a layered architecture of a electronic greeting messaging system according to some aspects of the disclosure.

FIGS. 7-12 illustrate examples of text message encapsulation formats.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following attached description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

Systems, methods, and apparatus are described herein for sending and receiving encapsulated messages, such as electronic greeting cards. While many of the examples described herein are described with respect to an electronic greeting card, the disclosure is not so limited. The systems, methods, and apparatus described herein are equally applicable to other types of electronic communication. A plurality of message encapsulation formats may be provided that mimic real-world scenarios. Sensors on a computing device, such as a smartphone, may be used to send and/or retrieve an encapsulated greeting card. For example, a selected message encapsulation format may require an action to be performed using a sensor to send and/or retrieve an encapsulated message. Input from multiple senders may be encapsulated and combined to create a single greeting card that can be sent to one or more recipients. The systems, methods, and apparatus described herein provide context to a message through visual effects.

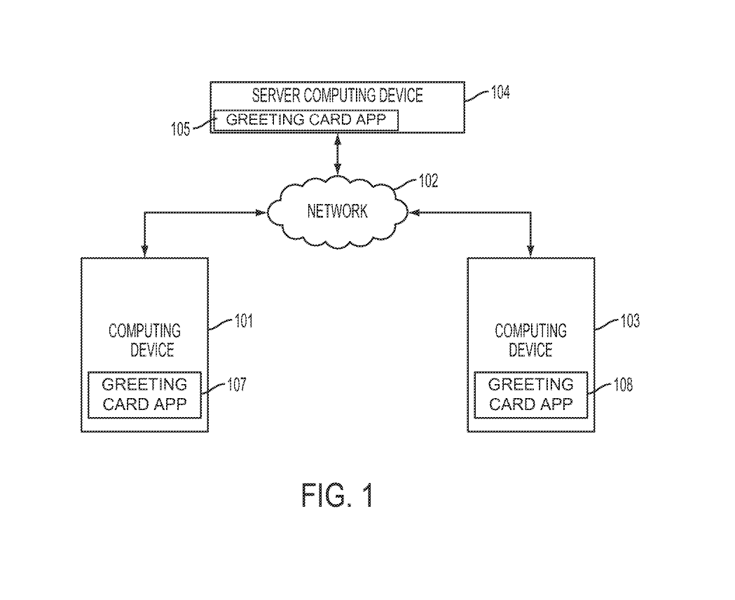

FIG. 1 is a block diagram of one aspect of the system described herein for sending and receiving encapsulated electronic greeting cards. Computing device 101 may be coupled through network 102 to communicate over a communication link with computing device 103 during a communication session. Computing device 101 and computing device 103 may communicate view one or more communication protocols such as, for example, text, instant messaging, email, Internet, etc. Both computing device 101 and computing device 103 may also be connected through network 102 to a server computing device 104 (e.g., a server) to obtain a copy of greeting card application 105. While two computing devices are illustrated in FIG. 1, this is merely illustrative. A single computing device or more than two computing devices may implement the systems and methods described herein.

The greeting card application 105 may be configured to communicate with other local or remote services or applications to facilitate creating, sending, and receiving electronic greeting cards and/or otherwise interacting with the local or remote service or application. For example, the application 105 may be a standalone application configured to provide a platform for creating, sending, and retrieving an electronic greeting card or other electronic messages. In accordance with other aspects of the disclosure, the application 105 may facilitate creating an electronic greeting card or other message, and may communicate with a local application, such as an email, text, social media, a website or other application to send a message to the local user and/or a remote user. According to some aspects of the disclosure, the application 105 may be implemented as a plugin to a web service or API. For example, a social media provider may use application 105 to enable its users to create greetings or to interact with the social media provider through application 105. For example, when integrated into a social media application, application 105 may present an option for a user to “high five” the user's computing device to indicate agreement with a post on the social media site. Other interactions may also be provided.

Once obtained, a copy of the greeting card application 105 may be stored locally on each of computing device 101 and computing device 103. Computing device 101 may store a local copy 107 of the greeting card application 105 while computing device 103 may store a local copy 108 of the greeting card application 105. While only two computing devices are shown in FIG. 1, the systems and methods described herein are not limited to one-to-one communication. A plurality of computing devices may communicate amongst each other via both one-to-one and group communication means. Moreover, as described in more detail herein, multiple users may contribute to a greeting card destined for one or more users.

One of skill in the art will recognize that computing device 101 and computing device 103 can be identical devices or different types of devices. Computing device 101 and computing device 103 are preferably smartphones, such as an iPhone from Apple, Inc., a BlackBerry, from Research in Motion Limited, a phone running the Android OS from Google, Inc. of Mountain View, Calif., or the like. However, each computing device may be a home personal computer (PC), a corporate PC, a laptop, a netbook, or any network-enabled computing device. Examples of network-enable computing devices include a cellular phone, personal digital assistant (PDA), media device (such as an iPod from Apple, Inc.), an electronic tablet (such as an iPad from Apple, Inc.), or an electronic reader devices (such as the Kindle from Amazon.com, Inc. of Seattle, Wash.).

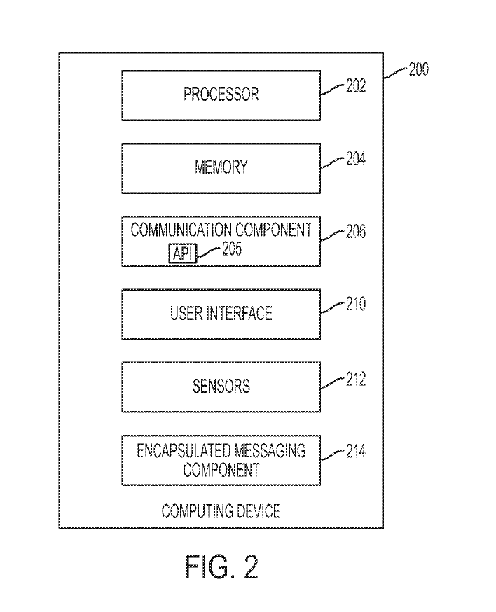

FIG. 2 shows an example of a computing device 200 that may be used to implement aspects of the disclosure. For example, computing device 101 and/or computing device 103, shown in FIG. 1, may include computing device 200. Computing device 200 may include a processor 202 for carrying out processing functions associated with one or more of components and functions described herein. Processor 202 can include a single or multiple sets of processors or multi-core processors. Moreover, processor 202 can be implemented as an integrated processing system and/or a distributed processing system.

Computing device 200 further includes a memory 204, such as for storing data and/or local versions of applications being executed by processor 202. Memory 204 can include any type of memory usable by a computer, such as a computer-readable medium, a random access memory (RAM), read only memory (ROM), tapes, magnetic discs, optical discs, volatile memory, non-volatile memory, databases, and any combination thereof.

Further, computing device 200 may include a communications component 206 that provides a means for establishing and maintaining communications over one or more communication links with one or more parties utilizing hardware, software, and services as described herein. Communications component 206 may carry communications between components on computing device 200, as well as between the computing device 200 and external devices, such as devices located across a network and/or devices serially or locally connected to computing device 200. For example, communications component 206 may include one or more buses, and may further include transmit chain components and receive chain components associated with a transmitter and receiver, respectively, operable for interfacing with external devices. In accordance with some aspects of the disclosure, communications component 206 may include one or more application programming interfaces (APIs) 205 for accessing processor 202 and/or the data from one or more sensors 212.

Computing device 200 may additionally include a user interface component 210 operable to receive inputs from a user of computing device 200, which may be further operable to generate outputs for presentation to the user. User interface component 210 may include one or more input devices, including but not limited to a keyboard, a number pad, a mouse, a touch-sensitive display, a navigation key, a function key, a microphone, a voice recognition component, a still camera, a video camera, an audio recorder, and/or any other mechanism capable of receiving an input, or any combination thereof. Further, user interface component 210 may include one or more output devices, including but not limited to a display, a speaker, a haptic feedback mechanism, a video projector, a printer, any other mechanism capable of presenting an output, or any combination thereof.

Computing device 200 may include a plurality of sensors 212. For example, sensors 212 may include touch screens, microphones, cameras, accelerometers, light sensors, proximity sensors, gyroscopes, biometric readers, temperature sensors, compasses, global positioning satellite (GPS) sensors, and/or other sensors. The sensors 212 may be configured to collect data indicating an action performed by a user of the computing device. According to aspects of the disclosure, the data may be used to determine whether an action required by the sender or recipient of a message, based on a chosen message encapsulation format, has been performed. Computing device 200 may also include encapsulated messaging component 214 configured to allow a user to send and receive encapsulated messages, such as encapsulated greeting cards associated with one or more actions. Additionally, encapsulated messaging component 214 may be configured to facilitate consolidating input from a plurality of users into a single greeting card to be consumed or viewed by one or more recipients. The encapsulated messaging component 214 may be configured to route the message among senders, gathering the necessary message and/or sensor actions from each sender prior to routing the message to the recipient.

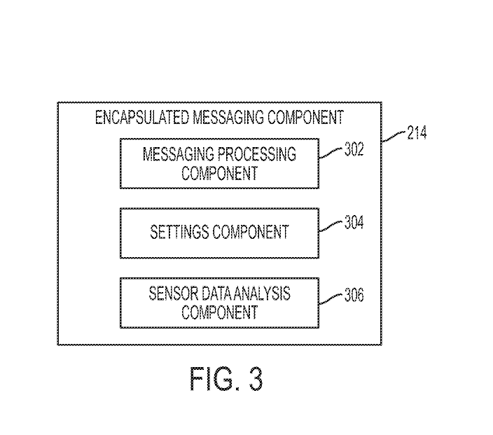

FIG. 3 illustrates an example of the encapsulated messaging component 214. As seen, the encapsulated messaging component 214 may include a message processing component 302 configured to facilitate sending or retrieving an electronic greeting card. Each message encapsulation format may be configured to visually represent a real-life scenario. For example, a text, an image, a sound, or a video message may be encapsulated into a greeting card, where a user has performed an action to send or view the encapsulated message. Each stored format may be associated with one or more actions, which may be in turn associated with one or more sensors. For example, the greeting card may include an image of a birthday cake with candles. To view the message inside the card, a user may be required to blow out the candles. Thus, in this example, the action associated with this message format may be blowing the candles, while the sensor for detecting the action may be a microphone. Each message format may require actions to be performed by the sender(s) to send a message or by the receiver(s) to receive a message. Message processing component 302 may be configured to present message encapsulation format options to a user, receive a user selection of an option, receive user input of the message to be encapsulated, and generate the encapsulated message.

As described above, the application 105 may be implemented as a plugin to a web service or API. For example, a website may use application 105 to promote an anniversary or other occasion. In this example, the website may select a birthday cake format, and may include a message with the birthday cake asking users to blow out a candle to receive a discount on one or more products. Any other types of interactions may also be supported.

Message processing component 302 may be further configured to detect whether a selected message format is a group message format. Group messages may be created by an initiator, may include a plurality of senders, and may be destined to one or more recipients. Message processing component 302 may be configured to determine the number and identity of senders, the number and identity of receivers, and to facilitate routing a group message to the plurality of senders and receivers.

A settings component 304 may be provided for customizing how messages are sent and received. For example, settings component 304 may enable a user to set a time limit or expiration point indicating how long a message is displayed or stored after being viewed. In some aspects, settings component 304 may be configured to enable a user to turn off any requirements to perform an action to retrieve a message. Moreover, settings component 304 may present options for providing confirmation to senders after a receiver has viewed a message.

Sensor data analysis component 306 may be configured to process sensor data to determine whether required actions have been performed. The sensor data analysis component 306 may be configured to collect data from the sensors and compare the received data to the requirements associated with a selected greeting card format to determine whether a message should be sent or retrieved.

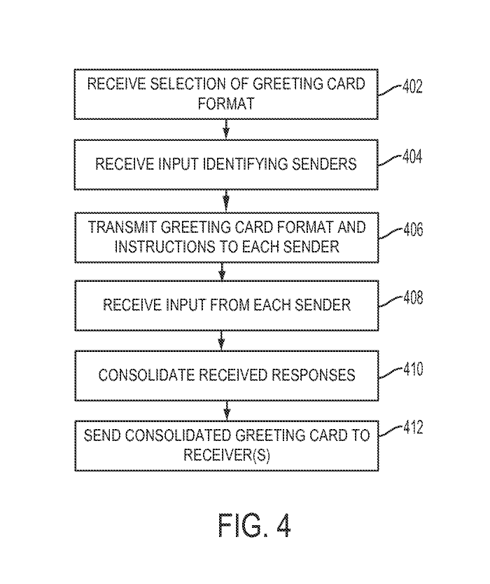

As described herein, greeting cards may be sent from a plurality of senders to one or more recipients. FIG. 4 is a flowchart illustrating an example of a method for sending a consolidated group electronic greeting card in accordance with aspects of the disclosure. As shown at 402, a computing device may receive a user selection of a greeting card format. Each card format may be associated with one or more actions that may be required of a sender to send the message and/or a recipient to receive the message. The actions may mimic a real world action, such as, for example, blowing out the candles on a birthday cake or sending a bear hug.

As shown at 404, the computing device requests and receives input of identifying information for the senders of the consolidated group electronic greeting card. The senders may include the initiator and one or more additional senders. Identifying information may include, for example, name, email address, user identifier, telephone number, and or any other identifying information that can be used to route the message.

As shown at 406, the computing device transmits the message to each of the identified sensors using the identifying information. The computing device may transmit a copy of the selected greeting card as well as instructions for providing input.

As shown at 408, the computing device receives input from each sender. The input may include the message text, voice, images, graphics, etc. to be included in the group consolidated message. According to some aspects of the disclosure, a message format may require a sender to perform an action to initiate the sending of a message. As such, the input may also include data representing an action taken by the sender.

As shown at 410, the computing device consolidates the responses received from each sender, and as shown at 412, sends the message to the recipient(s).

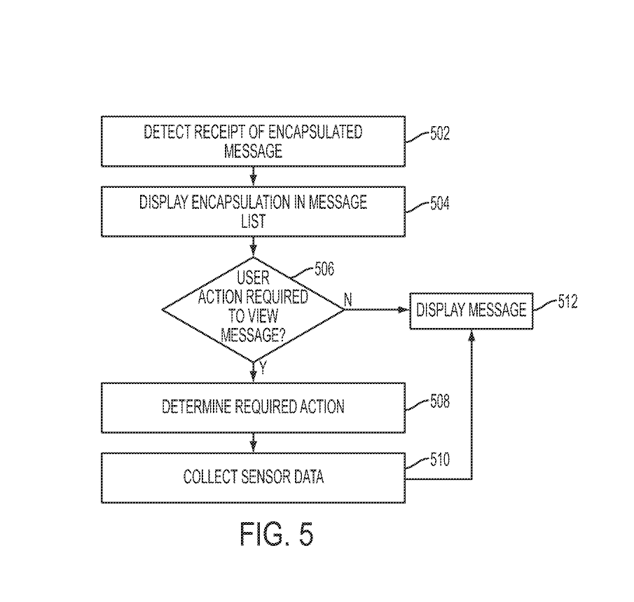

FIG. 5 illustrates a process for receiving an encapsulated message, such as an encapsulated greeting card. As shown at 502, a computing device may detect receipt of a greeting card. The encapsulated greeting card message may be displayed in a graphical user display provided by the greeting card application, as shown at 504. The display may include instructions for retrieving the encapsulated message. The instructions may be textual, auditory or graphical.

As shown at 506, the computing device determines whether an action required to retrieve the encapsulated greeting card has been performed. If no action is required, the message can be displayed, as shown at 512. If an action is required, the computing device determines the required action, as shown at 508, and collects sensor data to determine that the action has been performed, as shown at 510. The messages may then be displayed, as shown at 512.

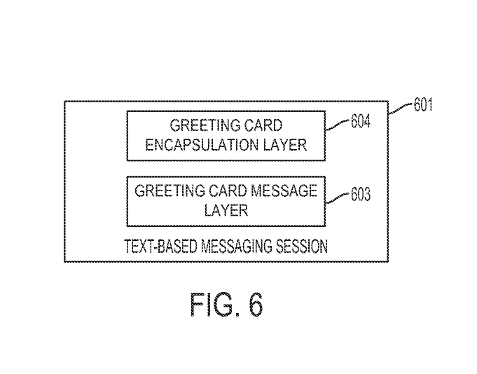

The messaging system described herein may consist of two layers, as illustrated in FIG. 6. The data collected representing user actions, from the sender and/or receiver device, may be layered on top of the message or animation sent. During a communication session 601, messages may be conveyed between a sending computing device and one or more receiving computing devices in a greeting card message layer 603 using known messaging communication protocols.

The message to be delivered may be encapsulated using a message encapsulation format in the greeting card encapsulation layer 604. Messages may be encapsulated visually. For example, the message to be transmitted may be embedded in a graphical image that may require the recipient to perform an action prior to viewing the message. The greeting card encapsulation layer 604 may be configured to provide metadata specifying the greeting card encapsulation format in use. Additionally, any data collected representing the action performed may form part of the greeting card encapsulation layer.

Examples of types of encapsulated messages will now be described. These are merely examples of the types of message encapsulation formats that may be provided. Any other format may also be used.

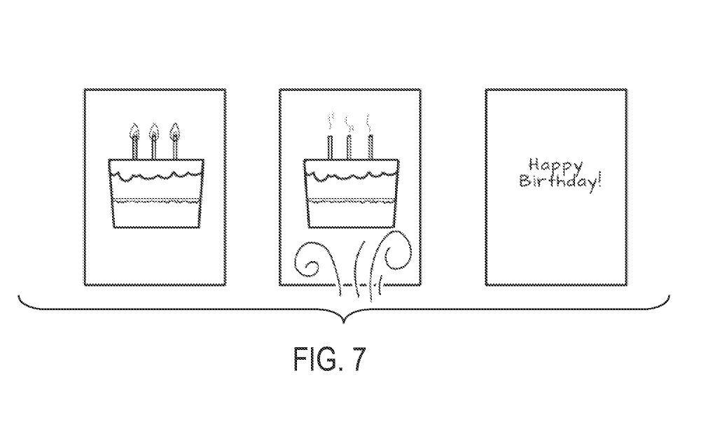

FIG. 7 illustrates an example of a greeting card that includes a cake with candles on it. The greeting card may include a “happy birthday” message. The greeting card format may be customizable, enabling a sender to select the number of candles to include on the cake, to personalize the message, etc. A receiver of the message may receive a notification that a greeting card has been received and instructions for reading the card. In this example, the instructions may require the user to simulate blowing the candles out. For example, user may blow into a microphone on the user's electronic device to reveal the happy birthday message. According to some aspects of the disclosure, the sender may receive a confirmation that the receiver blow out the candles on the cake.

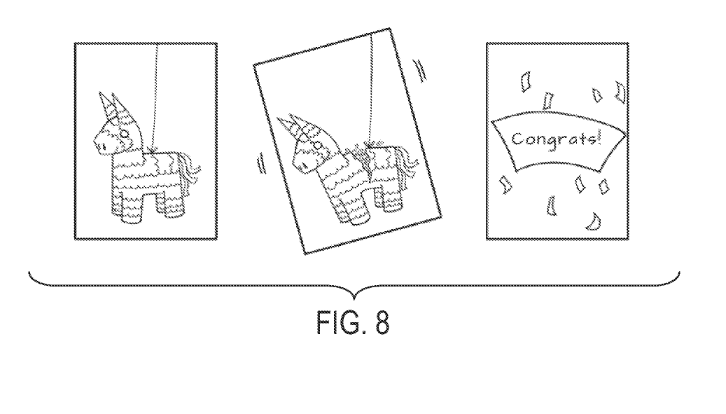

FIG. 8 illustrates another example, wherein the greeting card includes an image of a piñata that must be “broken” to retrieve an embedded message. In this example, a receiver of this message may be instructed to break the piñata by shaking the phone to reveal a message.

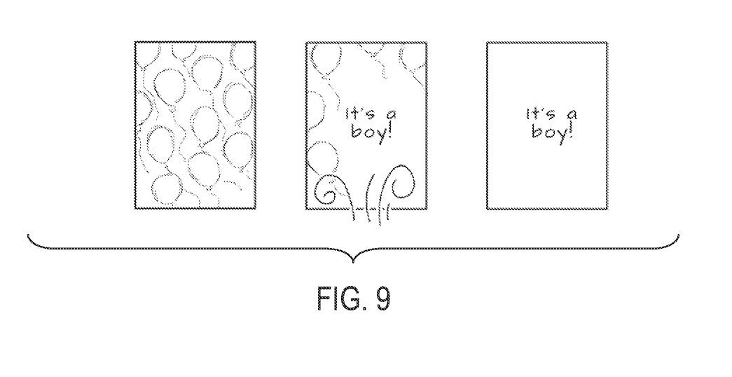

In yet another example shown in FIG. 9, the greeting card may comprise a plurality of balloons with a message hidden behind the balloons. One or more actions may be required to reveal the message such as, for example, tapping the screen to “pop” the balloons, blowing into the microphone to cause the balloons to “fly away,” shaking the device to reveal portions or the entire message behind the balloons, etc.

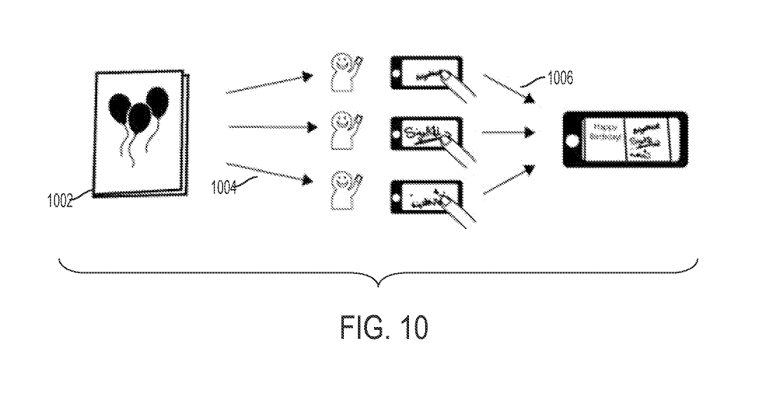

FIG. 10 illustrates an example of sending a group electronic greeting card to be signed by a group of senders before being forwarded to a receiver. An initiator selects a card format, as shown at 1002, and selects a list of senders to digitally sign the card. The card is then forwarded to the list of senders, as shown at 1004. Each sender may digitally sign the card, for example, by swiping their fingers or a stylus on the screen of their electronic device. The signatures may be forwarded back to the initiator, and the group card, with all signatures, may be forwarded to the receiver, as shown at 1006. According to some aspects of the disclosure, the senders may receive notifications that the recipient received and opened the greeting card. While in this example, the receiver is not required to perform an action to open and view the greeting card, other greeting card formats may require the receiver to perform one or more actions.

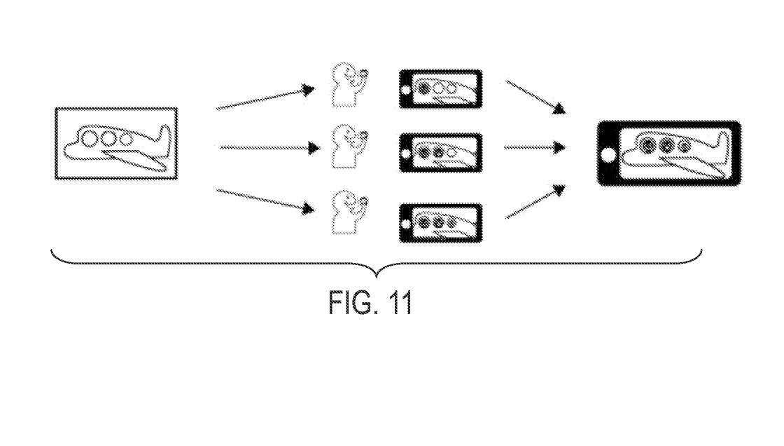

FIG. 11 illustrates another example of sending a group electronic greeting card. In this example, the selected greeting card format includes an image of an airplane with windows. The card may be sent to each sender with instructions to take a photograph of themselves (e.g., a “selfie”) to fill the windows in the airplane. Once all photographs have been added, the greeting card may be forwarded to the recipient.

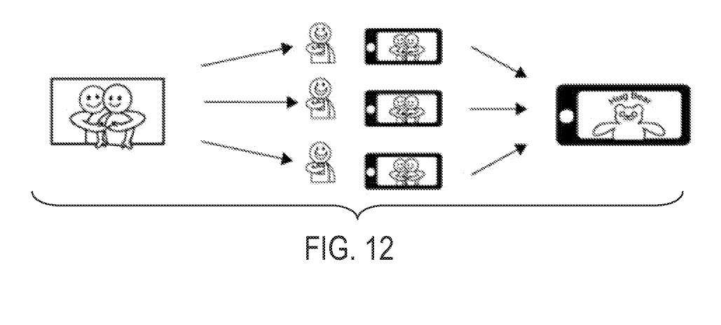

In yet another example, as shown in FIG. 12, the greeting card format may mimic sending a bear hug to the recipient. Each sender may mimic hugging the recipient by hugging the phone. After all (or some) hugs have been collected, the greeting card may be forward to the receiver.

While various examples have been described herein, it is to be understood that such examples are given for illustrative purposes only and can be extended to other implementations and embodiments with different sets of sensors, defined types of motions, conventions, and techniques. While a number of embodiments are described herein, there is no intent to limit the disclosure to the embodiments disclosed herein. In the contrary, the intent is to cover all alternatives, modification, and equivalents apparent to those familiar with the art.

Further, while a number of examples are described as an application running on a computing device, it is to be understood that the application itself, along with the ancillary functions such as sensor operation, device communications, user input, and device display generation, etc., can all be implemented in software stored in a computer readable storage medium for access as needed to run such software on the appropriate processing hardware of the computing device.

A “computer,” as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a smart phone, a cellular telephone, a tablet, a web-book, a notebook computer, a desktop computer, a workstation computer, a server, a cloud, or the like, or an array of processors, microprocessors, central processing units, general purpose computers, super computers, personal computers, laptop computers, palmtop computers, notebook computers, desktop computers, workstation computers, servers, or the like.

A “database,” as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “network,” as used in this disclosure, means any combination of software and/or hardware, including any machine, device, circuit, component, or module, or any system of machines, devices, circuits, components, modules, or the like, which are capable of transporting signals from one location to another location, where the signals may comprise information, instructions, data, and the like. A network may include, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), or the like, any of which may be configured to communicate data via a wireless and/or a wired communication medium.

A “server,” as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any of its computers, may also be used as a workstation.

A “communication link,” as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, and the like. One or more communication links may be used in an environment 100 (shown in FIG. 1) to allow sufficient data throughput and interaction between end-users (such as, e.g., agents, consumers, insurance carriers, estate planners, financial providers, web host providers, and the like). Techniques for implementing such communications links are known to those of ordinary skilled in the art.

The terms “including,” “comprising,” “having,” and variations thereof, as used in this disclosure, mean “including, but not limited to,” unless expressly specified otherwise.

The terms “a,” “an,” and “the,” as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium,” as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer-readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications or modifications of the disclosure.

What is claimed:

1. A method for sending an encapsulated group message, the encapsulated group message including input from at least two senders, the method comprising:
initiating a group message by selecting a group message format, the group message format specifying one or more actions to be performed by each sender of the group message;
transmitting the group message to each sender along with instructions for providing input;
receiving, from each sender, input for the group message, wherein the input includes sensor data collected from a sending device;
correlating the sensor data with the one or more actions to be performed by each sender of the group message; and
transmitting the group message to at least one receiver.

2. The method of claim 1, wherein said group message format further specifies an action to be performed by the at least one receiver to view the group message.

3. The method of claim 1, wherein the sensor data is collected from at least one sensor associated with the sending device.

4. The method of claim 3, wherein the at least one sensor comprises a touch screen, a light sensor, an accelerometer, a proximity sensor, a gyroscope, a camera, a compass, a temperature sensor, a GPS sensor, a fingerprint sensor, a speech recognition sensor, or a microphone.

5. The method of claim 1, wherein the group message comprises a greeting card, the greeting card including one or more of a text message, an image message, a sound message and a video message.

6. The method of claim 1, wherein the one or more actions mimic a real world activity.

7. The method of claim 1, further comprising:
setting a deletion time for deleting the group message.

8. The method of claim 1, further comprising:
receiving a confirmation that the group message was viewed at the receiving device.

9. The method of claim 1, wherein the sensor data comprises one or more of a representation of device movement, a representation of a sound generated, a representation of light intensity, a representation of a location of the device, a representation of speech recognition, and a representation of an orientation of the device.

10. The method of claim 1, further comprising:
selecting a delivery method for transmitting the group message to each sender; and
entering an identifier for each sender, wherein the identifier type is based on the selected delivery method.

11. The method of claim 10, wherein the identifier comprises an email address, a telephone number, or a custom user identification.

12. A method for sending an encapsulated group message, the encapsulated group message including input from at least two senders, the method comprising:
initiating a group message by selecting a group message format, the group message format specifying one or more actions to be performed by each sender of the group message;
receiving, from each sender, input for the group message, wherein the input includes sensor data collected from a sending device;
correlating the sensor data with the one or more actions to be performed by each sender of the group message; and
transmitting the group message to at least one receiver.

13. The method of claim 12, wherein said group message format further specifies an action to be performed by the at least one receiver to view the group message.

14. The method of claim 12, wherein the sensor data is collected from at least one sensor associated with the sending device.

15. The method of claim 12, wherein the group message comprises a greeting card, the greeting card including one or more of a text message, an image message, a sound message and a video message.

16. The method of claim 12, further comprising:
receiving a confirmation that the group message was viewed at the receiving device.

17. The method of claim 12, wherein the sensor data comprises one or more of a representation of device movement, a representation of a sound generated, a representation of light intensity, a representation of a location of the device, a representation of speech recognition, and a representation of an orientation of the device.

18. A method for delivering an electronic greeting card through a website, comprising:
receiving a selection of a greeting card format, the greeting card format specifying specifying one or more actions to be performed by a viewer of the electronic greeting card;
receiving a message to be encapsulated in the electronic greeting card, the message viewable upon performance of the one or more actions;
displaying the greeting card on the website;
receiving sensor data indicating an action performed by the viewer;
determining that the sensor data corresponds to the one or more actions specified by the greeting card format; and
displaying the encapsulated message.

19. The method of claim 18, wherein the electronic greeting card comprises one or more of a text message, an image message, a sound message and a video message.

20. The method of claim 18, wherein the sensor data comprises one or more of a representation of movement of a viewer device, a representation of a sound generated, a representation of light intensity, a representation of a location of the viewer device, a representation of speech recognition, and a representation of an orientation of the viewer device.
